(19) United States
(12) Patent Application Publication
(10) Pub. No.: US 2017/0128843 A1
(43) Pub. Date: May 11, 2017

(54) SYSTEMS, METHODS, AND APPARATUSES FOR EXTRACTING AND ANALYZING LIVE VIDEO CONTENT

(71) Applicant: Versaci Interactive Gaming, Inc., Las Vegas, NV (US)

(72) Inventor: Joseph Versaci, Las Vegas, NV (US)

(21) Appl. No.: 15/279,328

(22) Filed: Sep. 28, 2016

Related U.S. Application Data
(60) Provisional application No. 62/234,011, filed on Sep. 28, 2015.

(51) Int. Cl. A63F 13/86; G06K 9/66; G06K 9/00

(52) U.S. Cl. CPC A63F 13/86; G06K 9/00758; G06K 9/66; G06K 2009/00738

(57) ABSTRACT

Systems, methods, and apparatuses for extracting and analyzing streaming gaming video data are disclosed. The methods involve receiving streaming gaming video data, extracting individual frames, analyzing individual frames to determine the location of objects and occurrence of events, using the objects and events to determine a change in game state, and updating the game state.

### BACKGROUND

1. Technical Field

The present disclosure relates to systems, methods, and apparatuses for extracting and analyzing live video content. More particularly, the present disclosure relates to devices and methods for extracting video frames from a video stream, analyzing the frame, and extracting usable data from the analysis.

2. Description of Related Art

In the video gaming field, streams of data are exchanged between a main server and players of the game. The players input commands, typically through a controlling device, that are effectuated by the characters involved in the video stream. According to the participant's action, the game progresses. As the game progresses, various elements change, include a score, a character location, and various other visually perceptible elements. Generally, these individual elements are stored on the server providing the video data stream, and rarely is the information saved for an extended period of time or put to any use.

Additionally, there exists a market in which people wager on the competition result. Many may wish to wager on the result of a game between players competing in video gaming. However, at this time, there is no service that will allow for such wagering, as there is no recording of data to allow for verifiable, secure results.

### SUMMARY

Image processing devices allow for the extraction of information from video content in a number of fields. Image processors are used in a variety of fields in order to recognize objects according to groupings of common pixels. Once objects are determined, the objects are compared to known objects in order to determine the object type or difference between object types. No system exists for adapting an image processing device to gaming between parties online. However, a system would be useful in order for a third party to read data and create a secure file showing a game result.

There is a need for systems, methods, and apparatuses for extracting data from video generated during the competition of two players using gaming consoles. There is a need for advanced and real-time analysis of gameplay video to determine game occurrences in order to establish reliable game data for the institution of in-game tracking by third party entities. The systems, methods, and apparatuses of the present disclosure allow a third party to analyze a gaming stream between two or more parties in order to determine occurrences that may be analyzed in order to create independent and verifiable game data.

According to an aspect of the present disclosure, a method involves analyzing a frame of a gaming video. The method includes the initial steps of collecting stream information for a user, determining when a video stream begins, reading stream data, splitting a stream into frames, analyzing individual frames to determine frames containing a game identity and events, and storing metadata, game identity, and events data and developing a model of the events data.

According to another aspect of the present disclosure, a method involves identifying a game stream. The method includes reading a video stream from an unknown game, extracting frames from the stream, mapping frame data and identifying frame details to develop a model, comparing the model to a stored model, and determining game information.

According to another aspect of the present disclosure, a method involves developing a game match model. The method includes creating an empty model, determining when a game has begun, extracting game frames from a game stream, identifying and extracting match data or events, creating a match model using a state machine, and comparing the model to the model and/or states of a previous iteration.

According to another aspect of the present disclosure, a method involves storing an exemplar mode. The method includes reading known example video data, extracting frames from the video data, mapping frame data and identifying frame details, and storing frame data and details as an exemplar model.

Yet another aspect of the present disclosure includes a device and method for developing a key system of recognizing elements of a video feed. The method including receiving a video stream and extracting single frames from the video stream. The method further includes parsing, cropping, and performing processing to standardize pixel placement on key elements of individual frames. The method may further include digitizing print elements to create a compressed image profile through, for example, ocular character recognition (OCR). The method may further include converting the compressed image profile into a unique string, value or key based on the print element digitization and the standardization of pixel placement of key elements.

Additionally, the process may further include comparing the unique string, value or key to stored unique strings, values or keys, wherein if the unique string, value or key is matched to a stored unique string, value or key, the frame is graded according to the stored unique string, value or key, and if the unique string, value or key is not matched to a stored unique string, value or key, the frame is flagged, graded manually, and the unique string, value or key may be saved for future reference. Saved strings, values or keys may be collected to develop a reference database for future analysis.

According to an additional aspect of the present invention, any of the above devices or methods may include flagging the process for human intervention or interaction when any of the above-described values cannot be determined automatically with a certain level of certainty.

According to yet another aspect of the present invention, any of the above devices or methods may include creating a text result and transferring the text result to user devices or platforms.

### BRIEF DESCRIPTION OF THE DRAWINGS

Objects and features of the presently-disclosed systems, methods, and apparatuses for extracting and analyzing live video content will become apparent to those of ordinary skill in the art when descriptions of various embodiments thereof are read with reference to the accompanying drawings, of which:

FIG. 1 is a flow chart of a process for determining gaming video events and extracting data;

FIG. 2 is a flow chart of a process for analyzing an unknown stream of video data;

FIG. 3 is a flow chart of a process for continually updating a game model; and

FIG. 4 is a flow chart of a process for analyzing a known stream of video data.

### DETAILED DESCRIPTION

Hereinafter, embodiments of the presently-disclosed systems, methods, and apparatuses for extracting and analyzing live video content with reference to the accompanying drawings. Like reference numerals may refer to similar or identical elements throughout the description of the figures.

This description may use the phrases “in an embodiment,” “in embodiments,” “in some embodiments,” or “in other embodiments,” which may each refer to one or more of the same or different embodiments in accordance with the present disclosure.

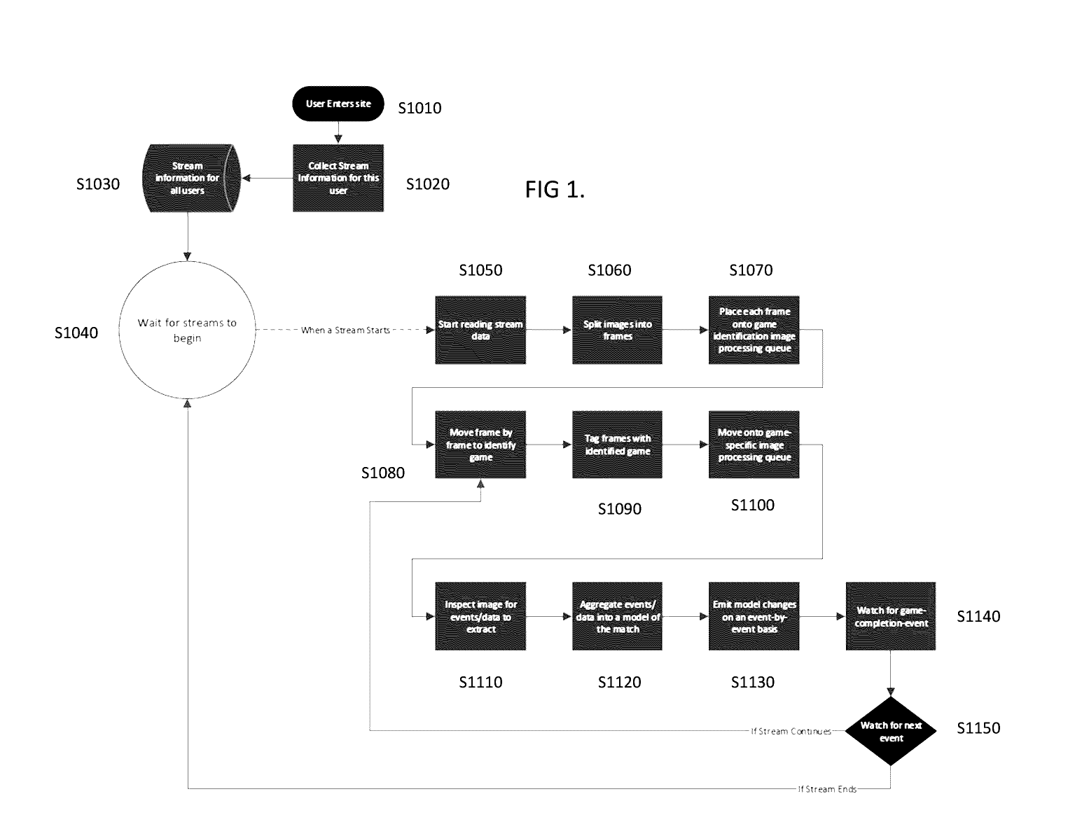

FIG. 1 illustrates a process for determining and extracting gaming video events and data. The process begins with step S1010, where a user, who will participate in the playing of a video game, connects to a system tasked with performing the steps described below. In step S1020, user information is read into the system, and in step S1030, the streams of video data associated with every user involved in a given video game is received by a receiving unit. The system waits for video data to stream in step S1040. When it is determined that video data is streaming, step S1050 commences to read in the streaming data.

The data is then split into individual frame data (step S1060) and each individual frame is placed into a queue in order to analyze and identify the frame (step S1070). Frames from the queue are processed one by one in order to identify the game occurring (step S1080) and once the game identification succeeds, a data tag is added to the data of each frame indicating the game identity (step S1090).

Once each frame has been tagged, frames are returned to another queue (step S1100) where they wait for further processing. Moving out of the second queue, the system inspects the image, searching for important or useful symbols or images indicating certain events, and extracts the data of the events for further analysis (step S1110). Once a number of frames have been inspected for events, the event data is aggregated to create a model of the match indication, for instance, score, players, characters, progress, and other point of game status (step S1120). The newly created model is compared to a past created model or an exemplary model in order to determine changes in the model based on a changing event and output, as data, changes to the model (step S1130).

The process continues while no frame indicates an end event or until the system determines that there are no further frames to analyze. The process watches for end events and lack of remaining frames in step S1140. The process may include wait for a period of time before performing a check to determine if there is an end event. In step S1150, the system checks to see if another game event may occur. If such an event will occur, the process resumes from step S1080 and performs step S1080 through step S1150 with the continuing stream of frames until it is determined that no remaining events will occur. When it is determined that no further events will occur, the system enters a waiting mode in which the system periodically checks for a new stream of data to begin.

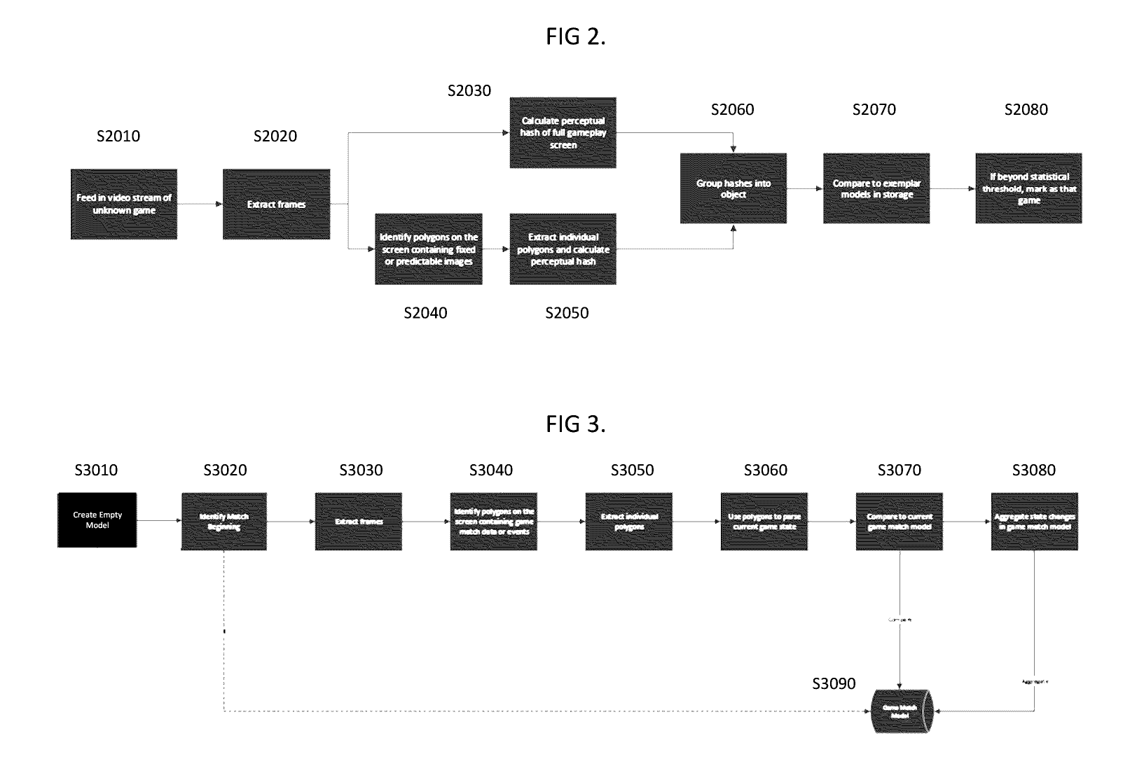

FIG. 2 illustrates a process for analyzing an unknown stream of video data. In step S2010, a video stream of an unknown game is received, and data pertaining to the individual frames of the video data are extracted from the stream in step S2020. For each frame, a perceptual hash of a full screen is performed, in step S2030, as well as a perceptual hash, in step S2050, of individual polygons that are identified on the screen as fixed images or predictable/expected images, in step S2040. The results of the perceptual hashing of the whole and various elements are then grouped as objects and create object data, in step S2060.

The object data is compared to the data of a stored game model, in step S2070. If the similarities between the object data and the stored game model indicate, with a reasonable level of certainty, the type of game the video stream is created by, the frames and stream are marked or identified as being from the type of game. Frames may be stored as image data or image frames themselves may be saved.

FIG. 3 illustrates a process for creating and continually updating a game model. In step 3010, an empty model is created with reserved data entry locations. The model remains empty at least until the beginning of a match is identified, in step S3020. Upon determining that a match has begun and video data is streaming, the video data is received and individual frames are extracted from the stream, in step S3030.

Extracted individual frames are analyzed and various objects and/or events are determined by, for example, identifying polygons containing game data, in step S3040, and extracting the object/event data. The polygon object/event data is then parsed to determine various elements and create a game state with various state elements describing the progress and other features of the game. The parsed data and other segmented data taken from the stream is saved in a database and arranged as data bundles with similar data from other streams. The game state is then compared, in step S3070, to either an exemplar game match model saved within the database or compared to a previous model of the game from earlier stream data. Differences between the game state and either of the model states are determined and aggregated to develop a new game match model. Once all the data from the stream has been saved and categorized, the system further analyses the data to produce grades and statistics for the game to be to the users associated with the stream. Frames may be saved as frame data. Frames may additionally be saved in their pure image form.

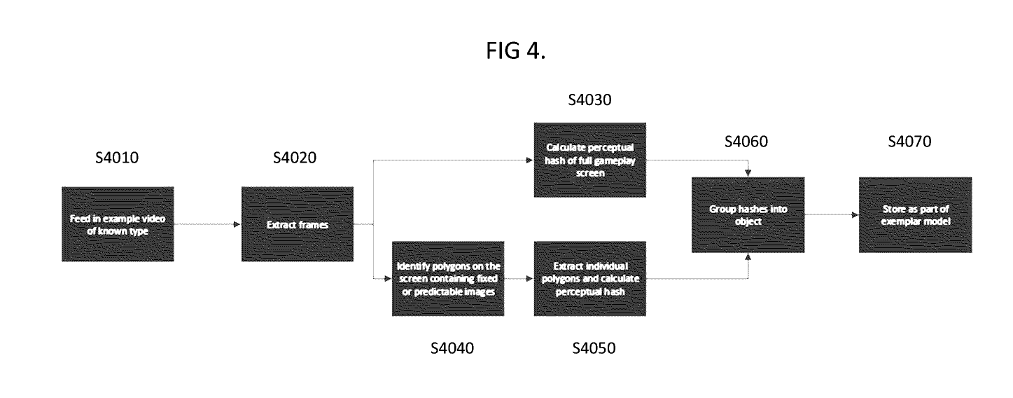

FIG. 4 illustrates a process for analyzing a known stream of video data. In step S4010, a video stream of a known game is received, and data pertaining to the individual frames of the video data are extracted from the stream in step S4020. For each frame, a perceptual hash of a full screen is performed, in step S4030, as well as a perceptual hash, in step S4050, of individual polygons that are identified on the screen as fixed images or predictable/expected images, in step S4040.

The results of the perceptual hashing of the whole and various elements are then grouped as objects and create object data, in step S4060. The object data is then stored as part of an exemplar model, in step S4070. If the similarities between the object data and the stored game model indicate, with a reasonable level of certainty, the type of game the video stream is created by, then the frames and stream are marked or identified as being from the type of game.

Although embodiments have been described in detail with reference to the accompanying drawings for the purpose of illustration and description, it is to be understood that the inventive processes and apparatus are not to be construed as limited thereby. It will be apparent to those of ordinary skill in the art that various modifications to the foregoing embodiments may be made without departing from the scope of the disclosure.

What is claimed is:

1. A method comprising:
obtaining stream information for a user;
determining when a video stream begins;
reading stream data;
splitting the stream data into frames;
analyzing each of the frames to determine frames containing a game identity and events data;
storing metadata, the game identity, and the events data in memory; and
developing a model of the events data.

2. A method comprising:
reading a video stream from an unknown game;
extracting frames from the video stream;
mapping frame data;
identifying frame details to develop a model;
comparing the developed model to a model stored in memory; and
determining game information.

3. A method of developing a game match model, comprising:
creating an empty model;
determining when a game has begun;
extracting game frames from a game stream;
identifying and extracting match data or events from the game frames;
creating a match model using a state machine; and
comparing the match model to the model or states of a previous iteration.

4. A method of creating and storing an exemplar model, comprising:
reading known example video data;
extracting frames from the known example video data;
mapping frame data and identifying frame details based on the extracted frames; and
storing frame data and frame details as an exemplar model.
